(19) United States
(12) Patent Application Publication
(10) Pub. No.: US 2018/0144755 A1
(43) Pub. Date: May 24, 2018

(54) METHOD AND APPARATUS FOR INSERTING WATERMARK TO AUDIO SIGNAL AND DETECTING WATERMARK FROM AUDIO SIGNAL

(71) Applicant: Electronics and Telecommunications Research Institute, Daejeon (KR)

(72) Inventors: Mi Suk LEE, Daejeon (KR); Seung Kwon BEACK, Daejeon (KR); Jongmo SUNG, Daejeon (KR); Tae Jin LEE, Daejeon (KR)

(73) Assignee: Electronics and Telecommunications Research Institute, Daejeon (KR)

(21) Appl. No.: 15/710,353

(22) Filed: Sep. 20, 2017

(30) Foreign Application Priority Data
Nov. 24, 2016 (KR) 10-2016-0157272
Jun. 9, 2017 (KR) 10-2017-0072321

(51) Int. Cl. G10L 19/018; H04H 20/31; H04H 60/37; H04H 60/58; H04N 21/2389; H04N 21/8358; H04N 5/067

(52) U.S. Cl. CPC G10L 19/018; H04H 20/31; H04H 60/37; H04H 60/58; G06F 17/30743; H04N 21/8358; H04N 5/0675; H04H 2201/50; H04N 21/23892

(57) ABSTRACT

Disclosed is an audio watermark insertion method. The audio watermark insertion method includes performing a modulated complex lapped transform (MCLT) on a first audio signal, inserting a bit string of a watermark in the first audio signal obtained by performing the MCLT, performing an inverse modified discrete cosine transform (IMDCT) on the first audio signal in which the bit string is inserted, and obtaining a second audio signal, which is the first audio signal in which the watermark is inserted, by performing an overlap-add on a signal obtained by performing the IMDCT and a neighbor frame signal.

### CROSS-REFERENCE TO RELATED APPLICATION

This application claims the priority benefit of Korean Patent Application No. 10-2016-0157272 filed on Nov. 24, 2016, and Korean Patent Application No. 10-2017-0072321 filed on Jun. 9, 2017, in the Korean Intellectual Property Office, the disclosures of which are incorporated herein by reference.

### BACKGROUND

### 1. Field

Example embodiments of the following description relate to a method and apparatus for inserting an audio watermark and detecting the audio watermark, and more particularly, to a method and apparatus for inserting a bit string of a watermark in an audio signal transformed through a modulated complex lapped transform (MCLT) and detecting the bit string of the watermark.

### 2. Description of Related Art

Watermarking refers to a process of inserting information such as copyright information in various types of data, for example, an image and a video, and managing the inserted information. Here, the information to be inserted may generally include information associated with a copyright, an owner, a usage limit, and the like, and also include other information such as a uniform resource locator (URL) address of a website, which is information associated with contents, based on a purpose of use of a watermark.

The following three factors may need to be considered when performing such watermarking. The first factor is imperceptibility. The insertion of a watermark should not affect a quality of original contents. That is, the watermark needs to be unrecognizable to human beings, although the original contents are distorted by the insertion of the watermark. The second factor is robustness. The watermark needs to be detectable, although the original contents in which the watermark is inserted are forged or manipulated. The third factor is security. The watermark needs to remain undetected and unremoved by unauthorized detection, although the presence of the watermark is recognized.

A watermark is classified into an audio watermark and a video watermark based on original contents in which the watermark is to be inserted. Compared to a video signal, an audio signal may have a relatively insufficient amount of data, and thus have a relatively insufficient area in which a watermark is to be inserted. In addition, human beings may more sensitively respond to an audio signal than a video signal. Thus, the audio watermark needs to be used based on such a characteristic of an audio signal.

However, in an existing method of inserting a watermark in an audio signal, detection may not be readily performed in a situation such as, for example, a delay and cropping, that may occur in a signal processing process and a transmission/reception process. Therefore, there is a desire for technology for generating, inserting, and detecting a watermark satisfying the three factors described in the foregoing despite various challenging situations that may occur in a signal processing process and a transmission/reception process.

### SUMMARY

An aspect provides a method and apparatus for inserting and detecting an audio watermark that is robust against signal processing that may occur when transmitting, storing, and reproducing (or playing) an original audio signal, within a range unrecognizable to human beings, by using a modulated complex lapped transform (MCLT).

Another aspect provides a method and apparatus for inserting and detecting an audio watermark that is robust against a situation such as a delay and cropping, and signal processing such as a codec, by performing a phase modulation and inserting a watermark in an MCLT coefficient.

Thus, aspects of the present disclosure provides a method and apparatus for inserting and detecting an audio watermark that is used as technology for transmitting various sets of information such as a uniform resource locator (URL) address in addition to a copyright.

According to an aspect, there is provided an audio watermark insertion method including performing a modulated complex lapped transform (MCLT) on a first audio signal, inserting a bit string of a watermark in the first audio signal obtained by performing the MCLT, performing an inverse modified discrete cosine transform (IMDCT) on the first audio signal in which the bit string is inserted, and obtaining a second audio signal, which is the first audio signal in which the watermark is inserted, by performing an overlap-add on a signal obtained by performing the IMDCT and a neighbor frame signal.

The bit string, which indicates information to be inserted in the first audio signal, may be generated using a pseudo-noise (PN) sequence through a spread-spectrum method.

A length of the PN sequence may be determined based on a service.

The inserting of the bit string may include inserting the bit string in an MCLT coefficient by the length of the PN sequence.

The inserting of the bit string may include selecting a frequency band that is not damaged despite a passage of a codec, and inserting the bit string in the selected frequency band.

According to another aspect, there is provided an audio watermark detection method including receiving a second audio signal obtained by inserting a watermark in a first audio signal and performing a modified discrete cosine transform (MDCT) on the received second audio signal, extracting a bit string of the watermark using the second audio signal obtained by performing the MDCT, and detecting the watermark using the extracted bit string.

The bit string, which indicates information to be inserted in the first audio signal, may be generated using a PN sequence through a spread-spectrum method.

A length of the PN sequence may be determined based on a service.

The extracting of the bit string may include extracting the bit string using an MDCT coefficient obtained by performing the MDCT.

The detecting of the watermark may include detecting the watermark by measuring a distance between the PN sequence and the extracted bit string.

According to still another aspect, there is provided an audio watermark inserting apparatus including a processor. The processor may perform an MCLT on a first audio signal, insert a bit string of a watermark in the first audio signal obtained by performing the MCLT, perform an IMDCT on the first audio signal in which the bit string is inserted, and obtain a second audio signal, which is the first audio signal in which the watermark is inserted, by performing an overlap-add on a signal obtained by performing the IMDCT and a neighbor frame signal.

The bit string, which indicates information to be inserted in the first audio signal, may be generated using a PN sequence through a spread-spectrum method.

A length of the PN sequence may be determined based on a service.

The processor may insert the bit string by inserting the bit string in an MCLT coefficient by the length of the PN sequence.

The processor may insert the bit string by selecting a frequency band that is not damaged despite a passage of a codec, and inserting the bit string in the selected frequency band.

According to yet another aspect, there is provided an audio watermark detecting apparatus including a processor. The processor may receive a second audio signal obtained by inserting a watermark in a first audio signal and perform an MDCT on the received second audio signal, extract a bit string of the watermark using the second audio signal obtained by performing the MDCT, and detect the watermark using the extracted bit string.

The bit string, which indicates information to be inserted in the first audio signal, may be generated using a PN sequence through a spread-spectrum method.

A length of the PN sequence may be determined based on a service.

The extracting of the bit string may include extracting the bit string using an MDCT coefficient obtained by performing the MDCT.

The detecting of the watermark may include detecting the watermark by measuring a distance between the PN sequence and the extracted bit string.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 is a diagram illustrating an overall process of inserting and detecting an audio watermark according to an example embodiment;

FIG. 2 is a flowchart illustrating a method of inserting a watermark in an audio signal, which is performed by an audio watermark inserting apparatus, according to an example embodiment;

FIG. 3 is a flowchart illustrating a method of generating a watermark to be inserted in an audio signal, which is performed by an audio watermark generating apparatus, according to an example embodiment;

FIG. 4 is a flowchart illustrating a method of detecting a watermark from an audio signal, which is performed by an audio watermark detecting apparatus, according to an example embodiment; and

FIG. 5 is a diagram illustrating a method of detecting a watermark according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described herein that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, example embodiments are described in detail with reference to the accompanying drawings. Like reference numerals in the drawings denote like elements, and a known function or configuration will be omitted herein.

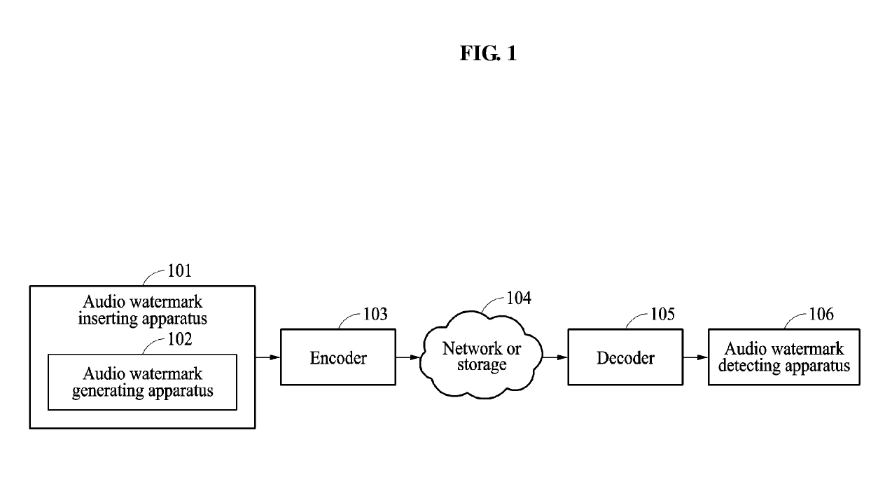

FIG. 1 is a diagram illustrating an overall process of inserting and detecting an audio watermark according to an example embodiment.

A watermark, which is information to be inserted in an original audio signal, may be generated by an audio watermark generating apparatus 102. The audio watermark generating apparatus 102 may be located inside or outside an audio watermark inserting apparatus 101.

The audio watermark inserting apparatus 101 may insert, in an original audio signal, a bit string of a watermark that is generated by the audio watermark generating apparatus 102. Hereinafter, a first audio signal refers to an original audio signal, and a second audio signal refers to an audio signal obtained by inserting a bit string of a watermark in the original audio signal.

An encoder 103 may encode a second audio signal, which is the original audio signal in which the bit string is inserted, to an audio bitstream. The audio bitstream may be transmitted through a network 104, or stored in a storage 104. A decoder 105 may receive the audio bitstream through the network 104 or the storage 104, and decode the encoded second audio signal.

An audio watermark detecting apparatus 106 may detect the watermark from the decoded second audio signal. The second audio signal can be reproduced through a device such as a speaker or a headphone simultaneously with the detection of the watermark. When the second audio signal is reproduced, a user may not recognize a distortion of the original audio signal. In addition, the watermark may also be detected from the second audio signal even in a situation such as a delay or cropping that may occur in signal processing such as conversion of a codec/sampling rate for transmission and storage, or in a transmission/reception process.

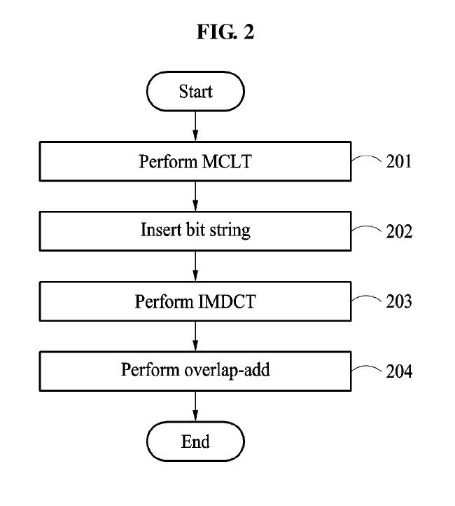

FIG. 2 is a flowchart illustrating a method of inserting a watermark in an audio signal, or simply referred to as an audio watermark insertion method, which is performed by an audio watermark inserting apparatus, according to an example embodiment.

Referring to FIG. 2, in operation 201, the audio watermark inserting apparatus performs a modulated complex lapped transform (MCLT) on a first audio signal, which is an original audio signal. An MCLT-based audio data transmission system may insert, in an audio signal, a signal that is not recognizable by human beings and transfer information through the audio signal. Here, the MCLT may be used to transform an audio signal on a time domain to frequency domain.

According to an example embodiment, the MCLT may be performed on an audio signal to insert information, and a phase of an MCLT coefficient may be changed to insert data. Here, an overlap of the MCLT may prevent a rapid change in a phase of data, thereby preventing a degradation of a sound quality.

When a time domain signal with a length of 2M is input, the MCLT may indicate a transformation that transforms the time domain signal to a frequency domain signal with a length of M. Here, by an inverse transformation, a signal may be obtained through an overlap between neighbor MCLT frames. The MCLT coefficient may be represented by a modified discrete cosine transform (MDCT) coefficient and a modified discrete sine transform (MDST) coefficient as in Equation 1.

X=Xc−jXs=CWS−jSWx [Equation 1]

In Equation 1, a real part Xc denotes an MDCT coefficient, and an imaginary part Xs denotes an MDST coefficient. W, C, and S denote a window, a cosine vector, and a sine vector, respectively. x denotes a vector representing an original audio signal with a length of 2M. In Equation 1, the window is 2M×2M and the cosine/sine vector is M×2M matrix, and thus a signal to be input is represented by 1×2M matrix.

Here, the window is an analysis window that is to be multiplied by a time domain signal, and may use sin [(n+½)×pi/2M]. That is, when an analysis is performed by a frame unit in audio coding, a hamming window may be an example of the window. In addition, the cosine/sine vector may indicate an M×2M cosine/sine modulation matrix.

In operation 202, the audio watermark inserting apparatus inserts a bit string of a watermark to the MCLT coefficient. Here, the bit string may be generated by an audio watermark generating apparatus. The bit string of the watermark may be inserted in the first audio signal transformed by the MCLT through Equation 2.

X′(f)=|X(f)|D(f) [Equation 2]

In Equation 2, D(f) denotes a bit string generated by the audio watermark generating apparatus, where f denotes an index of an MCLT coefficient in a frequency band in which the bit string is to be inserted. The index indicates what number is the MCLT coefficient. For example, when inserting a watermark in a 100-th MCLT coefficient among 1 through M MCLT coefficients, 100 is the index f and X(f) indicates the 100-th MCLT coefficient. In addition, X′(f) denotes an MCLT coefficient in which the bit string is inserted.

According to an example embodiment, a bit string that is spread to a pseudo-random noise (PN) sequence through a spread-spectrum method may be inserted in an MCLT coefficient. The spread-spectrum method used to spread the bit string to the PN sequence may indicate a method of modulating each bit of the bit string to the PN sequence. For example, when a bit string is {1 −1 1} and a PN sequence is {−1 −1 −1 1 −1 1 1}, the bit string that is spread to the PN sequence may be {−1 −1 −1 1 −1 1 1 1 1 1 −1 1 −1 −1 −1 −1 −1 1 −1 1 1}.

Here, when inserting a bit string in a high-frequency band the bit string may be damaged while passing a codec. Thus, the bit string may be inserted in a frequency band in which the bit string is not damaged even through the codec. For example, in a case of a low bit rate codec, the high-frequency band signals are coded with Band Width Extention (BWE) techniqus such as spectral band replication (SBR). In this case if the bit string is inserted in high-frequency band it is more easily damaged by the BWE. Therefore, it is important to insert a bit string in a frequency band that is less damaged in the coding process, especially in the case of a low bit rate codec.

In operation 203, the audio watermark inserting apparatus converts, the frequency band signal is converted to a time domain signal.

According to an example embodiment, the audio watermark inserting apparatus may apply an inverse MCLT (IMCLT) that is represented by an inverse MDCT (IMDCT) and an inverse MDST (IMDST) as in Equation 3. In Equation 3, T denotes a transposed matrix.

$$y = \frac{1}{2} {WC}^{T} Xc + \frac{1}{2} {WS}^{T} Xs \qquad [ Equation 3 ]$$

According to another example embodiment, the audio watermark inserting apparatus may perform the IMDCT on a real part of an MCLT coefficient or the IMDST on an imaginary part of the MCLT coefficient, as represented by Equation 4.

y=WC^{T}X_{c}, y=WS^{T}Xs [Equation 4]

The audio watermark inserting apparatus may perform the IMDCT only on the real part using Equation 4, and thus reduce an interference effect that may occur due to an overlap-add, or an overlap, between a real part coefficient and an imaginary part coefficient.

In operation 204, the audio watermark inserting apparatus obtains a second audio signal, which is the first audio signal, or the original audio signal, in which the watermark is inserted, by performing an overlap-add on the time domain signal and a neighbor frame signal. Here, the time domain signal is converted to a frequency domain signal by a frame or block unit, in general. For example, a sample such as 512 and 1024 may indicate a single frame.

When analyzing a signal, an aliasing may occur due to an overlap between adjacent time domain windows in a method of performing the overlap-add using a frame window. Here, a time domain aliasing cancellation (TDAC) method may be used to effectively remove the aliasing and completely restore the signal.

In the MDCT, a 50% overlap of a window may be allowed, and there may not be a required bit amount to be added. That is, to ensure a threshold sampling, despite a transformation through the 50% overlap of a window with a frame size of N, a completely restored signal may be obtained from N/2 samples.

Here, the obtained second audio signal may be encoded to an audio bitstream through an encoder, and then transmitted through a network or stored in a storage.

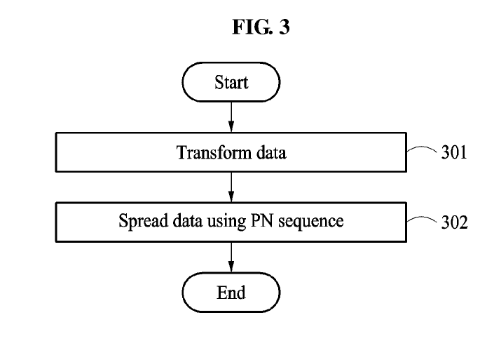

FIG. 3 is a flowchart illustrating a method of generating a watermark to be inserted in an audio signal, which is performed by an audio watermark generating apparatus, according to an example embodiment.

Referring to FIG. 3, in operation 301, the audio watermark generating apparatus transforms data, which is information to be inserted. For example, the audio watermark generating apparatus transforms the information to be inserted to a binary form represented by 1 and 0, and then replaces 0 with −1. That is, the information to be inserted, such as text, may be transformed to a binary form to be transmitted. Thus, the audio watermark generating apparatus may transform the data, which is the information to be inserted, to 1 and

In operation 302, the audio watermark generating apparatus generates a bit string of a watermark through a spread-spectrum method to spread the bit string to a PN sequence.

According to an example embodiment, various methods may be used as the spread-spectrum method for the spreading to the PN sequence. For example, using the PN sequence configured with 1 and −1, the data also configured with 1 and −1 may be spread. Here, the data to be inserted may be modulated using the PN sequence. For example, in a case in which the PN sequence is 1 1 1, 1 1 1 may be inserted when the data to be inserted is 1. In addition, −1 −1 −1 may be inserted when the data to be inserted is −1.

Here, in a case of the PN sequence with a long length, a distortion of an audio signal may increase although robustness may increase when detecting a watermark. Conversely, in a case of the PN sequence with a short length, robustness may decrease when detecting a watermark although a distortion of an audio signal may decrease. Thus, a length of the PN sequence may be selected based on a service. That is, in a case of the short length of the PN sequence, a bit error rate (BER) may increase in a distortion environment. Since a distortion may vary depending on a characteristic of a service, a length of the PN sequence may be selected based on a service to be provided.

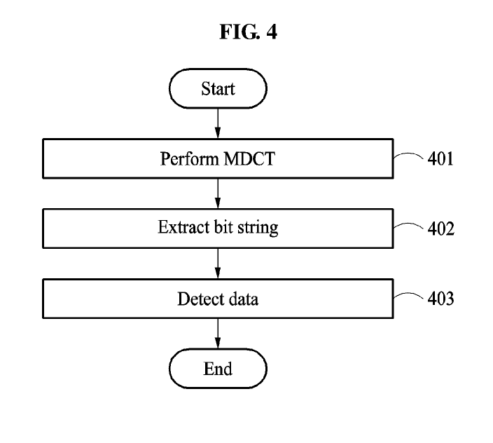

FIG. 4 is a flowchart illustrating a method of detecting a watermark from an audio signal, which is performed by an audio watermark detecting apparatus, according to an example embodiment.

Referring to FIG. 4, in operation 401, the audio watermark detecting apparatus performs an MDCT on a second audio signal decoded through a decoder. Here, the second audio signal refers to a signal obtained by inserting a watermark in a first audio signal, which is an original audio signal.

In operation 402, the audio watermark detecting apparatus extracts a bit string from an MDCT coefficient. For example, when a sign of the MDCT coefficient is positive, the bit string indicates 1. Conversely, when a sign of the MDCT coefficient is negative, the bit string indicates −1.

In operation 403, the audio watermark detecting apparatus detects data, which is inserted information, using the extracted bit string of the watermark. For example, data configured with 1 and −1 may be generated by measuring a distance between the extracted bit string and a PN sequence used by an audio watermark inserting apparatus. For example, when a result obtained by multiplying the bit string and the PN sequence and adding results of the multiplying is greater than 0, the data may be determined to be 1. When the result is less than 0, the data may be determined to be −1. In detail, in a case in which the PN sequence is 1 −1 1 and the extracted bit string is 1 1 1, 1 may be output because 1 is obtained after the PN sequence and the bit string are multiplied and results of the multiplying are added.

The audio watermark detecting apparatus may extract the information inserted in the first audio signal by transforming the generated data. Here, when the audio watermark detecting apparatus extracts the inserted information from the second audio signal, the second audio signal may be reproduced through a reproducing device such as speakers and headphones.

According to example embodiments, there is provided a method and apparatus for inserting a watermark in an original audio signal using an MCLT. The inserted watermark may be effectively detected despite a situation such as a delay and cropping, and signal processing using a codec.

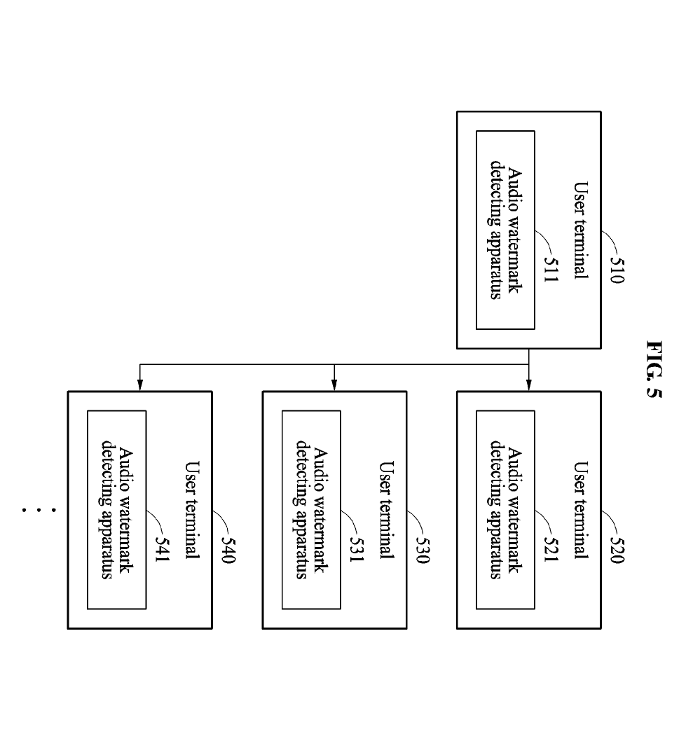

FIG. 5 is a diagram illustrating a method of detecting a watermark according to an example embodiment.

According to an example embodiment, a user terminal may include an audio watermark detecting apparatus. Alternatively, the user terminal may include the audio watermark detecting apparatus and a decoder.

Referring to FIG. 5, a user terminal 510 may detect a watermark, which is inserted information, from a second audio signal through an audio watermark detecting apparatus 511. In addition, the user terminal 510 may reproduce or play the second audio signal when detecting the watermark using the audio watermark detecting apparatus 511.

Here, the second audio signal that is reproduced may be received by another user terminal 520 through a device such as a microphone. The other user terminal 520 receiving the second audio signal may detect the watermark, which is the information inserted in the second audio signal, through an audio watermark detecting apparatus 521. Here, there may be a plurality of user terminals 520, 530, and 540 that receives the second audio signal from the user terminal 510 and detects the watermark.

For example, an audio watermark inserting apparatus may insert, as a watermark, a uniform resource locator (URL) address including information associated with a first audio signal, which is an original audio signal. The watermark may be detected by the user terminal 510 or the other user terminals 520, 530, and 540. A user may verify the information associated with the first audio signal through the detected URL address.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An audio watermark insertion method, comprising:
performing a modulated complex lapped transform (MCLT) on a first audio signal;
inserting a bit string of a watermark in the first audio signal obtained by performing the MCLT;
performing an inverse modified discrete cosine transform (IMDCT) on the first audio signal in which the bit string is inserted; and
obtaining a second audio signal, which is the first audio signal in which the watermark is inserted, by performing an overlap-add on a signal obtained by performing the IMDCT and a neighbor frame signal.

2. The method of claim 1, wherein the bit string indicating information to be inserted in the first audio signal is using a pseudo-noise (PN) sequence through a spread-spectrum method.

3. The method of claim 2, wherein a length of the PN sequence is determined based on a service.

4. The method of claim 1, wherein the inserting of the bit string comprises:
inserting the bit string in an MCLT coefficient by a length of a PN sequence.

5. The method of claim 1, wherein the inserting of the bit string comprises:
selecting a frequency band that is not damaged despite a passage of a codec; and
inserting the bit string in the selected frequency band.

6. An audio watermark detection method, comprising:
receiving a second audio signal obtained by inserting a watermark in a first audio signal, and performing a modified discrete cosine transform (MDCT) on the received second audio signal;
extracting a bit string of the watermark using the second audio signal obtained by performing the MDCT; and
detecting the watermark using the extracted bit string.

7. The method of claim 6, wherein the bit string indicating information to be inserted in the first audio signal is using a pseudo-noise (PN) sequence through a spread-spectrum method.

8. The method of claim 7, wherein a length of the PN sequence is determined based on a service.

9. The method of claim 6, wherein the extracting of the bit string comprises:
extracting the bit string using an MDCT coefficient obtained by performing the MDCT.

10. The method of claim 7, wherein the detecting of the watermark comprises:
detecting the watermark by measuring a distance between the PN sequence and the extracted bit string.

11. An audio watermark inserting apparatus, comprising:
a processor,
wherein the processor is configured to perform a modulated complex lapped transform (MCLT) on a first audio signal, insert a bit string of a watermark in the first audio signal obtained by performing the MCLT, perform an inverse modified discrete cosine transform (IMDCT) on the first audio signal in which the bit string is inserted, and obtain a second audio signal, which is the first audio signal in which the watermark is inserted, by performing an overlap-add on a signal obtained by performing the IMDCT and a neighbor frame signal.

12. The audio watermark inserting apparatus of claim 11, wherein the bit string indicating information to be inserted in the first audio signal is using is generated using a pseudo-noise (PN) sequence through a spread-spectrum method.

13. The audio watermark inserting apparatus of claim 12, wherein a length of the PN sequence is determined based on a service.

14. The audio watermark inserting apparatus of claim 11, wherein the processor is configured to insert the bit string by inserting the bit string in an MCLT coefficient by a length of a PN sequence.

15. The audio watermark inserting apparatus of claim 11, wherein the processor is configured to insert the bit string by selecting a frequency band that is not damaged despite a passage of a codec, and inserting the bit string in the selected frequency band.
